(19) United States
(12) Patent Application Publication
(10) Pub. No.: US 2026/0175754 A1
(43) Pub. Date: Jun. 25, 2026

(54) SEAT COVERING MANUFACTURING METHOD AND SEAT COVERING MANUFACTURED THEREBY

(71) Applicant: Man Hyun KIM, Incheon (KR)

(72) Inventor: Man Hyun Kim, Incheon (KR)

(73) Assignee: Man Hyun KIM, Incheon (KR)

(21) Appl. No.: 19/415,140

(22) Filed: Dec. 10, 2025

(30) Foreign Application Priority Data
Dec. 23, 2024 (KR) 10-2024-0193754

(51) Int. Cl. B60N 2/58

(52) U.S. Cl. CPC B60N 2/5891

(57) ABSTRACT

The present invention relates to a seat covering manufacturing method and a seat covering manufactured thereby, and more specifically, to a technology for manufacturing a seat covering by joining a knitted fabric having a napped surface to a rear side of a sponge using flame laminating or hot melt adhesive bonding, in a state where a leather is joined to a front side of the sponge such that the knitted fabric having the napped surface formed on the inner surface of the seat covering can serve the function of a loop member engaging with a hook of a seat pad over the entire area of the seat covering without the need to form a loop member corresponding to the hook of the seat pad on the inner surface of the seat covering, thereby improving productivity, enhancing coupling strength between the seat covering and the seat pad, and improving breathability.

### CROSS REFERENCE TO RELATED APPLICATIONS

This application claims the benefit under 35 U.S.C. § 119(a) of Korean Patent Application No. 10-2024-0193754 filed on Dec. 23, 2024 in the Korean Intellectual Property Office, the entire disclosures of which is incorporated herein by reference for all purposes.

### BACKGROUND OF THE INVENTION

### Field of the Invention

The present invention relates to a seat covering manufacturing method and a seat covering manufactured thereby, and more specifically, to a technology for manufacturing a seat covering by joining a knitted fabric having a napped surface to a rear side of a sponge using flame laminating or hot melt adhesive bonding, in a state where a leather is joined to a front side of the sponge such that the knitted fabric having the napped surface formed on the inner surface of the seat covering can serve the function of a loop member engaging with a hook of a seat pad over the entire area of the seat covering without the need to form a loop member corresponding to the hook of the seat pad on the inner surface of the seat covering, thereby improving productivity, enhancing coupling strength between the seat covering and the seat pad, and improving breathability.

### Background Art

In recent years, automobiles are no longer perceived merely as means of transportation, but rather as comfortable and safe spaces, as the amount of time that people spend inside cars increases. Accordingly, the quality of seats, out of interior parts of a vehicle, has become more important.

In general, a vehicle seat comprises a seat pad that fills the interior space and a seat covering that wraps the seat pad. As illustrated in FIGS. 1 to 3, a conventional seat covering is manufactured by bonding a fabric 11 such as natural or synthetic leather to a sponge 12, bonding a support fabric 13 to an inner surface of the sponge 12, and forming a loop member 14 on the support fabric 13 via sewing to engage with a hook 22 formed on the seat pad 20.

When the conventional seat covering 10 is covered onto the seat pad 20 to be joined, the loop member 14 of the seat covering 10 is fastened to the hook 22 of the seat pad 20, thereby fixing the seat covering 10 to the seat pad 20.

However, in such a conventional art, since the loop member 14 is formed on the support fabric of the seat covering by sewing at a position and in a shape corresponding to the hook 22 formed on the seat pad, it increases the time required for cutting the leather or fabric, the sewing time, and the overall production cost.

In addition, since the loop member 14 is formed on the support fabric 13 of the seat covering 10, the support fabric 13 is not flat over the entire area, and the loop member 14 protrudes downward from the support fabric 13. That is, the rear surface of the seat covering 10 is not flat due to the downward protrusion of the loop member 14.

Accordingly, in order to make the upper surface of the seat covering 10 flat when the seat covering 10 is covered over the seat pad 20, it is necessary to form a groove 21 in the seat pad 20 and to form a hook 22 in the groove 21. Then, when the loop member 14 of the seat covering 10 is inserted into the groove 21 and engaged with the hook 22, the upper surface of the seat covering 10 can be flat.

However, in this case, wrinkles are formed on the surface fabric 11 at the portion of the seat covering 10 where the loop member 14 is inserted into the groove 21 and engaged with the hook 22, resulting in deterioration of the appearance quality of the seat.

Meanwhile, as a conventional art related to vehicle seats, there is Korean Patent No. 10-1656303.

### SUMMARY OF THE INVENTION

Accordingly, the present invention has been made to solve the above-mentioned problems occurring in the prior arts, and it is an objective of the present invention to provide a technology for manufacturing a seat covering by joining a knitted fabric having a napped surface to a rear side of a sponge using flame laminating or hot melt adhesive bonding, in a state where a leather is joined to a front side of the sponge such that the knitted fabric having the napped surface formed on the inner surface of the seat covering can serve the function of a loop member engaging with a hook of a seat pad over the entire area of the seat covering without the need to form a loop member corresponding to the hook of the seat pad on the inner surface of the seat covering, thereby improving productivity, enhancing coupling strength between the seat covering and the seat pad, and improving breathability.

The objectives of the present disclosure are not limited to those mentioned above, and other objectives not mentioned herein will be clearly understood by those skilled in the art from the following description.

To accomplish the above object, according to the present invention, there is provided a seat covering manufacturing method including the steps of: (a) bonding a leather to a sponge; (b) forming a napped surface on a surface of a knitted fabric; and (c) bonding the knitted fabric having the napped surface to a rear surface of the sponge.

In this instance, the knitted fabric has a thickness of 0.2 to 1.0 mm and a density of 80 to 120 g/m².

In another aspect of the present invention, there is provided a seat covering including: a sponge; a leather bonded to a front surface of the sponge; and a knitted fabric bonded to a rear surface of the sponge, wherein a napped surface is formed on the knitted fabric.

In this instance, the knitted fabric has a thickness of 0.2 to 1.0 mm and a density of 80 to 120 g/m².

In a further aspect of the present invention, there is provided a seat for a vehicle including: a seat pad having a hook formed thereon; and a seat covering having a lower surface onto which a knitted fabric coupled to the hook of the seat pad is bonded, wherein an upper surface of the seat pad and the hook are continuously connected.

As described above, the present invention can manufacture a seat covering by joining a knitted fabric having a napped surface to a rear side of a sponge using flame laminating or hot melt adhesive bonding, in a state where a leather is joined to a front side of the sponge such that the knitted fabric having the napped surface formed on the inner surface of the seat covering can serve the function of a loop member engaging with a hook of a seat pad over the entire area of the seat covering without the need to form a loop member corresponding to the hook of the seat pad on the inner surface of the seat covering, thereby improving productivity.

The effects of the present disclosure are not limited to the above-mentioned effects, and other effects, which are not specifically mentioned herein, will be clearly understood by those skilled in the art from the following description.

### BRIEF DESCRIPTION OF THE DRAWINGS

FIGS. 1 and 2 are views illustrating a structure of a conventional seat covering.

FIG. 3 is a schematic diagram illustrating a coupling structure between a conventional seat covering and a seat pad.

FIG. 4 is a flowchart illustrating a seat covering manufacturing method according to an embodiment of the present invention.

FIG. 5 is a sectional view illustrating a seat covering manufactured by the seat covering manufacturing method according to an embodiment of the present invention.

FIG. 6 is a schematic diagram illustrating a coupling structure between the seat covering manufactured by the seat covering manufacturing method according to an embodiment of the present invention and a seat pad.

### DETAILED DESCRIPTION OF THE PREFERRED EMBODIMENT

Preferred embodiments of the present invention will now be described in more detail with reference to the accompanying drawings. However, well-known technical parts will be omitted or simplified for the sake of brevity.

Hereinafter, a seat covering manufacturing method according to a preferred embodiment of the present invention will be described in detail with reference to the accompanying drawings.

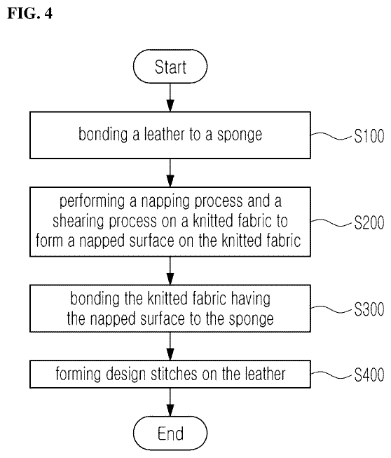

As illustrated in FIG. 4, the seat covering manufacturing method according to an embodiment of the present invention includes the steps of: bonding a leather to a sponge (S100); performing a napping process and a shearing process on a knitted fabric to form a napped surface on the knitted fabric (S200); bonding the knitted fabric having the napped surface to the sponge (S300); and forming design stitches on the leather (S400), thereby completing a seat covering.

First, a hot melt adhesive is applied to the front surface of the sponge, and a fabric such as leather is disposed on the front surface of the sponge. The sponge and the fabric are then thermocompression-bonded using upper and lower heating rollers, thereby bonding the leather or other fabric to the front surface of the sponge (S100). Here, polyurethane foam may be used instead of sponge as a base layer of the seat covering.

Next, a napping process and a shearing process are performed on the knitted fabric to form a napped surface on the knitted fabric (S200). The napping process is performed using a napping device to brush the surface of the knitted fabric and pull fiber ends upward to form fluffs (napped fibers). The shearing process is then performed using a shearing machine to cut the napped fibers to a uniform height for a smoother and more consistent surface.

Subsequently, heat is applied to a rear surface of the sponge to melt the rear portion of the sponge. A rear surface (the surface opposite to the napped surface) of the knitted fabric is placed on the melted rear portion of the sponge and is pressed using a pressure roller, thereby bonding the knitted fabric to the rear surface of the sponge by a flame laminating method (S300). Then, design stitches are formed on the leather (S400). Alternatively, the knitted fabric may be bonded to the sponge using a hot melt adhesive through heat and pressure instead of flame laminating.

In the present invention, it is preferable that the knitted fabric to be bonded to the rear surface of the sponge is made of 100% polyamide, but the material is not limited thereto.

It is also preferable that the knitted fabric to be bonded to the rear surface of the sponge has a thickness of 0.2 to 1.0 mm, and more preferably 0.25 to 0.4 mm, in order to ensure excellent engagement force with a hook of a seat pad and maintain favorable breathability. However, the thickness is not limited to the above range.

Furthermore, it is preferable that the knitted fabric has a density (basis weight) of 80 to 120 g/m², and more preferably 100 to 120 g/m², to ensure excellent engagement force with the hook of the seat pad and maintain favorable breathability. However, the density (basis weight) is not limited to to the above range.

Here, if the thickness of the knitted fabric is less than 0.2 mm or the density (basis weight) is less than 80 g/m², the engagement force may be insufficient, resulting in poor engagement with the hook of the seat pad. On the other hand, if the thickness exceeds 1.0 mm or the density (basis weight) exceeds 120 g/m², breathability may be reduced, impairing the performance of ventilated seats.

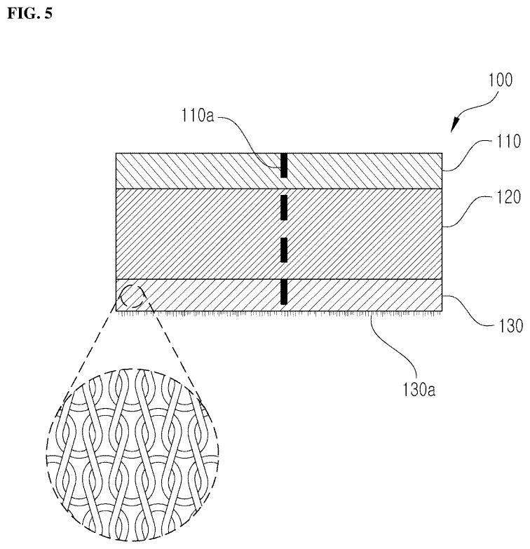

As illustrated in FIG. 5, the knitted fabric is formed by creating loops with a continuously connected yarn and interlinking the loops in succession. Therefore, the entire surface area of the knitted fabric can be considered to be formed from one continuous yarn. The napped surface formed on the knitted fabric is also generated from the single continuously connected yarn and thus can be considered as being integrally connected with the knitted fabric.

Accordingly, when an external force is applied to a specific portion of the knitted fabric while the napped surface of the knitted fabric is engaged with the hook of the seat pad, the structural characteristics of the knitted fabric and the napped surface formed from the single interconnected yarn allow for resistance to the external force not only at the point of application but also across the surrounding area. That is, the napped surface formed through the napping process is a part of the yarn itself, and is thus integrally connected with the knitted fabric. As a result, even when a pulling force is applied to the napped surface, the napped surface does not easily detach from the knitted fabric unless it is broken, providing high resistance to detachment and maintaining its position. Additionally, due to the structural advantage, the napped surface can be formed even in fabrics of low thickness, thus significantly improving the engagement strength between the hook of the seat pad and the seat covering.

In contrast, a short-fiber nonwoven fabric, which provides a soft touch, is manufactured by entangling a web through a needle punching process of short staple fibers. Each fiber in the nonwoven fabric is merely entangled rather than interconnected. Therefore, the fibers of nonwoven fabric can resist forces up to the limit of entanglement, but the fibers may separate from the web of the nonwoven fabric when a greater force exceeding the limit of entanglement is applied. As a result, the short-fiber nonwoven fabric must have sufficient thickness to provide adequate engagement force with the hook.

Moreover, in the seat covering of the present invention, the sponge and the knitted fabric are sequentially bonded to a rear surface of a leather. The sponge, being a porous and elastic material, provides a soft cushioning sensation to enhance comfort for an occupant. In this instance, the knitted fabric is bonded to the rear surface of the sponge, and has a property of being highly elastic. Accordingly, even after the knitted fabric is bonded to the sponge, the knitted fabric does not interfere with the behavior of the sponge such as bending or stretching, so that the performance of the sponge can be fully exhibited, and the soft cushioning feeling provided to the occupant by the sponge can be preserved as it is, thereby maximizing the comfortable riding feeling provided to the occupant when the occupant sits on the vehicle seat.

Moreover, the knitted fabric exhibits excellent elasticity, enabling the knitted fabric to return to its original shape quickly once an external force is removed, without retaining the deformed shape. Therefore, the overall elasticity (resilience) of the seat covering is improved, allowing it to maintain its original shape even after repeated application of external force by the occupant. In other words, the durability of the seat covering is enhanced.

Additionally, since the knitted fabric is a material with excellent breathability, forming the rear surface of the seat covering with the knitted fabric allows for improved breathability and maintaining excellent engagement force.

Moreover, as described above, since the napped surface can be formed on the knitted fabric even when the knitted fabric is thin, the thickness of the knitted fabric can be reduced, which further enhances breathability.

Through the above process, as illustrated in FIG. 5, a seat covering 100 is manufactured in which a leather 110 is bonded to a front surface of a sponge 120, and a knitted fabric 130 with a napped surface 130a formed thereon is bonded to a rear surface of the sponge 120, and design stitches 110a are formed.

As described above, in the present invention, the seat covering 100 is manufactured by bonding the knitted fabric 130 having the napped surface 130a formed thereon to the rear surface of the sponge 120 by a flame laminating method, in a state where the leather 110 is bonded to the front surface of the sponge 120.

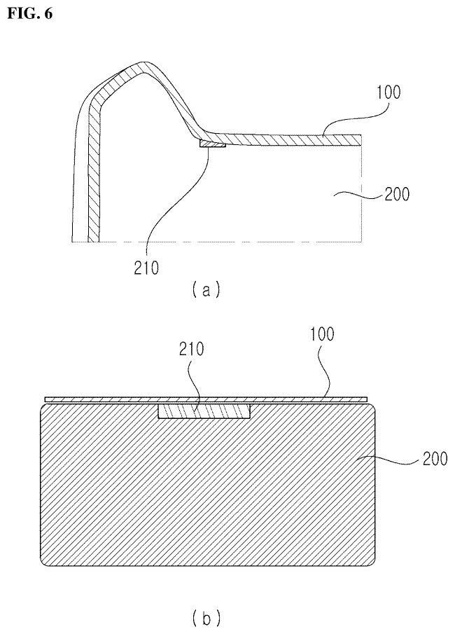

Accordingly, as illustrated in FIGS. 5 and 6, the knitted fabric 130 having the napped surface 130a formed on the inner surface of the seat covering 100 performs the function of a loop structure that engages with a hook 210 of a seat pad 200 across the entire area. Therefore, there is no need to separately form a loop member corresponding to the hook 210 on the inner surface of the seat covering 100, thereby improving productivity.

In this instance, since the present invention does not require the formation of a loop member, it is possible to omit the alignment process between the design stitch 110a of the seat covering 100 and the loop member, reducing production costs.

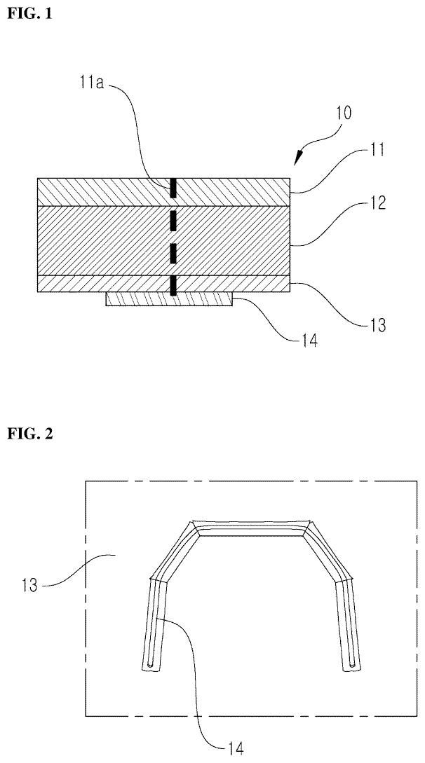

That is, in the conventional seat covering 10, as shown in FIGS. 1 and 2, a loop member 14 must be separately formed on a support fabric 13 bonded to the rear surface of a sponge 12. In order to ensure sufficient engagement force of the loop member 14 with the seat covering 10, it is necessary to position the loop member 14 in a region where design stitches 11a are formed. Moreover, since the region where the design stitches 11a are formed is subject to abrupt changes in the shape of the seat covering 10, the loop member 14 must be arranged in the region where the design stitches 11a are formed to minimize the sense of heterogeneity.

Therefore, to improve the engagement force of the loop member 14 and minimize the sense of heterogeneity caused by the design stitches 11a, an additional process for aligning the design stitches 11a with the loop member 14 is required, thereby increasing production costs.

However, as shown in FIGS. 5 and 6, in the present invention, the knitted fabric 130 having the napped surface 130a formed on the inner surface of the seat covering 100 performs the function of the loop structure that engages with the hook 210 of the seat pad 200 across the entire area. Therefore, there is no need to separately form a loop member, and the alignment process between the design stitches 110a and the loop member can be omitted, reducing production costs.

Additionally, since no loop member is required in the present invention, it is also possible to omit the groove structure when forming the hook on the seat pad.

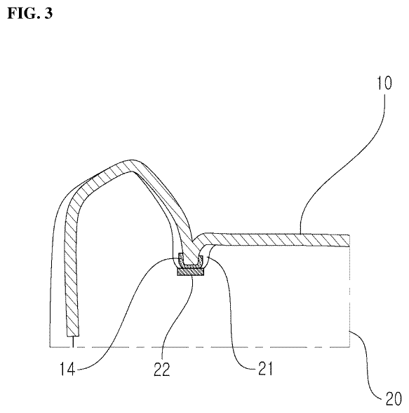

That is, in the conventional seat covering, as shown in FIG. 3, in order to make the upper surface of the seat covering 10 flat when mounted to the seat pad 20, a groove 21 must be formed in the seat pad 20 and a hook 22 must be formed in the groove 21. So, when the loop member 14 of the seat covering 10 is inserted into the groove 21 and engaged with the hook 22 and the seat covering 10 is coupled onto the seat pad 20, the upper surface of the seat covering 10 can remain flat.

However, in this case, when the loop member 14 of the seat covering 10 is inserted into the groove 21 and engaged with the hook 22, wrinkles may be formed on the surface fabric 11 at the location of the loop member 14, thereby degrading the external appearance quality of the seat.

However, a seat covering of the present invention, since a separate loop member is not required, the groove structure can be omitted when forming the hook 210 in the seat pad 200, as illustrated in FIG. 6. Accordingly, the present can prevent a deterioration in the appearance quality of a seat caused by the formation of wrinkles in the fabric of the seat covering as the loop member and the hook are engaged with each other inside the groove.

Meanwhile, the present invention can further improve breathability by densely perforating the knitted fabric, if necessary. In this instance, since the knitted fabric is firmly bonded to the sponge using flame laminating or hot melt adhesive bonding, the knitted fabric does not detach from the sponge even when it is densely perforated.

As described above, according to the present invention, in the state where the leather is bonded to the front surface of the sponge, the seat covering is manufactured by bonding the knitted fabric having the napped surface to the rear surface of the sponge using flame laminating or hot melt adhesive bonding. Accordingly, the knitted fabric having the napped surface formed on the inner surface of the seat covering performs the function of the loop member that engages with the hook of the seat pad over the entire area, so that there is no need to separately form a loop member, which corresponds to the hook of the seat pad, on the inner surface of the seat covering, resulting in improved productivity.

Since the present invention does not require the formation of a loop member, the alignment process between the design stitches and the loop member in the seat covering can be omitted, thereby reducing production costs.

The conventional arts require the formation of the loop member on the support fabric of the seat covering. Furthermore, in the conventional arts, to improve the bonding strength of the loop member to the seat covering, the loop member must be positioned in the region where the design stitches are formed, thereby ensuring sufficient engagement force. Additionally, because the region where the design stitches are formed causes sharp changes in the seat covering, placing the loop member in the region is essential to minimize the sense of heterogeneity.

Therefore, in order to improve the engagement force of the loop member and minimize the sense of heterogeneity caused by the design stitches, an additional process for aligning the design stitches with the loop member is required, leading to increased production costs.

However, in the present invention, since the knitted fabric having the napped surface formed on the inner surface of the seat covering performs the function of the loop structure that engages with the hook of the seat pad across the entire area, there is no need to separately form a loop member, such that the alignment process between the design stitch and the loop member can be omitted, thereby reducing production costs.

In addition, since there is no need to separately form a loop member in the present invention, the groove structure can be omitted when forming the hook on the seat pad. Accordingly, the present invention can prevent wrinkles from being formed in the seat covering fabric as a result of the loop member and hook engaging inside the groove, thereby preventing the appearance quality of the seat from being deteriorated.

Meanwhile, in the present invention, the knitted fabric bonded to the rear surface of the seat covering is formed by creating loops with a single continuous yarn and interweaving the loops in sequence. Accordingly, the entire area of the knitted fabric can be considered to be made of the single continuous yarn. Moreover, the napped surface formed on the knitted fabric is generated from the same single continuous yarn constituting the knitted fabric, and thus the napped surface can also be regarded as being integrally connected with the yarn of the knitted fabric.

As a result, when a pulling force is applied to a specific point of the knitted fabric while the napped surface of the knitted fabric is engaged with the hook of the seat pad, a resisting retention force is generated not only at the pulled point but also throughout the surrounding area, due to the integrated structure of the napped surface and the knitted fabric. In other words, the napped surface formed by the napping process on the knitted fabric is a part of the yarn that is lifted upward, and thus the napped surface and the knitted fabric are integrally formed. Therefore, even when the pulling force is applied to the napped surface, the napped surface maintains its attachment to the knitted fabric unless broken, which means the napped surface is not easily separated and retains its original position effectively. In addition, because of the above characteristics, the knitted fabric can form the napped surface even with a small thickness. Accordingly, such a structural advantage enhances the engagement force between the hook of the seat pad and the seat covering.

In contrast, soft-feel short fiber nonwoven fabrics are manufactured by binding short fibers into a web using a needle-punching process. In this case, the individual fibers are merely entangled, not connected. Thus, the fibers of the short fiber nonwoven fabrics can resist forces up to the point of fiber entanglement, but separate from the fabric once the force exceeds that threshold. Therefore, unless the short fiber nonwoven fabrics have a sufficient thickness, the holding force against hooks is inherently weak.

Furthermore, in the seat covering of the present invention, the sponge and the knitted fabric are sequentially bonded to the rear surface of the leather. The sponge, being a porous material with excellent elasticity, provides soft cushioning to enhance passenger comfort. The knitted fabric, being highly stretchable, is bonded to the rear surface of the sponge. Accordingly, even after the knitted fabric is bonded to the sponge, the knitted fabric does not interfere with behaviors of the sponge such as bending and stretching, so that the performance of the sponge can be fully exhibited, and the soft cushioning feeling provided to an occupant by the sponge is preserved as it is, thereby maximizing a comfortable riding feeling provided to the occupant when the occupant sits on a seat of a vehicle.

Moreover, due to the excellent stretchability of the knitted fabric, once external force is removed, the fabric quickly returns to its original shape. Accordingly, the overall elasticity of the seat covering is enhanced, allowing the seat covering to retain its original shape even after repeated external forces from occupants. That is, the durability of the seat covering can be improved.

Additionally, the knitted fabric, having excellent breathability, enhances air permeability and maintains strong engagement, when used on the rear surface of the seat covering.

As previously described, since the napped surface can be formed even on thin knitted fabric, the fabric can be made thinner, further improving breathability.

In addition, if needed, the knitted fabric may also be densely perforated to enhance breathability. Such dense perforation is carried out by repeatedly puncturing the surface of the knitted fabric with multiple closely spaced needles. The needle perforation widens the openings, improving air permeability. In this instance, since the knitted fabric is firmly bonded to the sponge via flame laminating or hot melt adhesive bonding, remaining securely fixed even after the dense perforation.

In the present invention, polyurethane foam may be used as a base layer of the seat covering in place of the sponge. In this case, the polyurethane foam has a “reticulated” structure in which cells are fully open, like a mesh network, thereby offering excellent air permeability. The reticulation process is performed using a reticulation chamber.

As previously described, in the detailed description of the present invention, having described the detailed exemplary embodiments of the invention, it should be apparent that the embodiments are presented merely as preferred examples of the present invention, and the present invention is not limited thereto. The scope of the present invention should be construed based on the following claims and their equivalents.

What is claimed is:

1. A seat covering manufacturing method comprising the steps of:
(a) bonding a leather to a sponge;
(b) forming a napped surface on a surface of a knitted fabric; and
(c) bonding the knitted fabric having the napped surface to a rear surface of the sponge.

2. The seat covering manufacturing method according to claim 1, wherein the knitted fabric has a thickness of 0.2 to 1.0 mm and a density of 80 to 120 g/m².

3. A seat covering comprising:
a sponge;
a leather bonded to a front surface of the sponge; and
a knitted fabric bonded to a rear surface of the sponge,
wherein a napped surface is formed on the knitted fabric.

4. The seat covering according to claim 3, wherein the knitted fabric has a thickness of 0.2 to 1.0 mm and a density of 80 to 120 g/m².

5. A seat for a vehicle comprising:
a seat pad having a hook formed thereon; and
a seat covering having a lower surface onto which a knitted fabric coupled to the hook of the seat pad is bonded,
wherein an upper surface of the seat pad and the hook are continuously connected.
